(19) United States
(12) Patent Application Publication
(10) Pub. No.: US 2005/0238286 A1
(43) Pub. Date: Oct. 27, 2005

(54) Method and apparatus for enhancing plasmon-polariton and phonon polariton resonance

(76) Inventor: Nabil M. Lawandy, Saunderstown, RI (US)

Correspondence Address: KIRKPATRICK & LOCKHART NICHOLSON GRAHAM LLP;(FORMERLY KIRKPATRICK & LOCKHART LLP), 75 STATE STREET, BOSTON, MA, 02109-1808, US

(21) Appl. No.: 11/100,339

(22) Filed: Apr. 6, 2005

Related U.S. Application Data
(60) Provisional application No. 60/559,791, filed on Apr. 6, 2004.
(60) Provisional application No. 60/565,754, filed on Apr. 27, 2004.
(60) Provisional application No. 60/576,215, filed on Jun. 2, 2004.

(51) Int. Cl. G02B 6/26

(52) U.S. Cl. 385/39

(57) ABSTRACT

A method for generating plasmon-polariton or phonon-polariton resonance effect including: providing structure capable of plasmon resonance; providing gain medium; and placing the structure in close juxtaposition to the gain medium. In one embodiment the structure has dimension D and is placed within distance less than or equal to D to, or within or partially within, the gain medium. The invention concerns material for enhanced plasmon resonance including gain medium; and structure capable of such resonance in close juxtaposition to the gain medium. In one embodiment the structure has a plasmon absorption curve, the gain medium has a gain curve and the peak of the plasmon absorption curve lies within the gain curve. The invention concerns a device for enhanced plasmon resonance including gain medium; structure capable of plasmon-polariton or phonon-polariton resonance in close juxtaposition to the gain medium; and a device for stimulating such resonance in the structure.

### RELATED APPLICATIONS

This application claims the benefit under 35 U.S.C. § 119(e) to U.S. Provisional Application No. 60/559,791 filed Apr. 6, 2004 and entitled “PLASMON ENHANCEMENT BY AMPLIFYING MEDIA,” and to U.S. Provisional Application No. 60/565,754 filed Apr. 27, 2004 and entitled “PLASMON ENHANCEMENT BY ACTIVE MEDIA,” and to U.S. Provisional Application No. 60/576,215 filed Jun. 2, 2004 and entitled “LOCALIZED SURFACE PLASMON SINGULARITIES IN AMPLIFYING MEDIA,” the entire disclosures of each of which are hereby incorporated herein by reference for all purposes.

### FIELD OF THE INVENTION

The invention relates to the field of optics, and more specifically to the field of plasmon-polariton and phonon polariton generation and applications.

### BACKGROUND OF THE INVENTION

A plasmon is a density wave of charge carriers which form at the interface of a conductor and a dielectric. Plasmons determine, to a degree, the optical properties of conductors, such as metals. Plasmons at a surface can interact strongly with the photons of light, forming a polariton. Plasmon excitations at interfaces with dimensions comparable to or significantly smaller than the wavelength of excitation do not propagate and are localized. In ionic materials, phonons can produce a negative dielectric response and result in phonon-polaritons. Small scale dimensions lead to localized plasmon-polariton and phonon polaritons.

Localized surface plasmons have been observed since the time of the Romans, who used gold and silver nanoparticles to create colored glass objects such as the Lycurgus Cup (4th Century A.D.). A gold sol in the British museum, created by Michael Faraday in 1857, is still exhibiting its red color due to the plasmon resonance at ˜530 nm. In more recent times, localized plasmons have been observed on rough surfaces and in engineered nanostructures and have led to the observation and exploitation of Surface Enhanced Raman Scattering (SERS) and new tunable plasmon structures with potential applications in biology and medicine.

### SUMMARY OF THE INVENTION

In one aspect, the invention relates to a method for generating a plasmon-polariton or phonon-polariton resonance effect including: providing a structure capable of such resonance; providing a gain medium; and placing the structure in close juxtaposition to the gain medium. In one embodiment the structure is a nanoparticle. In another embodiment the structure is a nanostructure. In another embodiment the structure has a dimension D and the structure is placed within a distance less than or equal to D to the gain medium. In yet another embodiment the structure is placed within the gain medium or partially within the gain medium.

In yet another aspect the invention relates to a material for enhanced plasmon-polariton and phonon-polariton resonance. The material includes a gain medium; and a structure capable of plasmon-polariton or photon-polariton resonance positioned in close juxtaposition to the gain medium. In another embodiment the structure has a plasmon absorption curve, the gain medium has a gain curve and the peak of the plasmon absorption curve lies within the gain curve.

In still yet another embodiment the invention relates to a device for enhanced plasmon resonance. The device includes a gain medium; a structure capable of plasmon-polariton and phonon-polariton resonance positioned in close juxtaposition to the gain medium; and a device for stimulating such resonance in the structure.

### BRIEF DESCRIPTION OF THE DRAWINGS

These and other aspects of the invention will be better understood by reference to the specification and drawings in which:

FIG. 1 is a diagram of the maximum internal and surface field as a function of β for various incident field values;

FIGS. 2 a-d are various embodiments of the invention; and

FIG. 3 is a depiction of a gain curve for the gain medium and the absorption curve for a plasmon resonant material.

FIG. 4 is a diagram showing a plasmon resonant material having a roughened surface placed in close juxtaposition to a P-N semiconductor junction forming an electrode.

### DESCRIPTION OF A PREFERRED EMBODIMENT

The invention herein relates to the use of the localized surface plasmon-polariton resonance on a surface in the presence of a gain medium. In one embodiment the surface is on a nanostructure that exhibits a greatly enhanced magnitude when the surrounding gain medium has gain near a critical value. In one embodiment this combination leads to large enhancements of the plasmon-polariton resonance even when the gain of the medium is saturated. Such a gain medium will exhibit strong scattering within the plasmon band leading to low threshold random laser light generation and light localization effects. The localization effect will greatly increase Surface Enhanced Raman Scattering signals for rapid single molecule detection, identification and sequencing.

Beyond the well studied single structure resonances is the response of clusters and aggregates. It has been shown theoretically and experimentally that homogenous aggregates of structures supporting localized surface plasmon-polariton resonances can lead to extremely large enhancement of local field amplitudes exceeding those of single structures. Of particular interest are “fractal” metal nanoparticle aggregates, which when combined with resonant microcavities have led to plasmon-polariton enhancements of the order of 10¹¹. Devices based on this effect are currently under development as ultra-sensitive gas and biological sensors.

Certain embodiments disclosed herein relate to the response of structures that support localized surface plasmon-polariton and phonon-polariton resonances when the surrounding medium is optically active. Specifically, it is shown that in the long wavelength or DC limit of the Maxwell Equations, at a critical value of amplification, in even the simplest of systems, a single metallic nanoparticle in a semi-infinite gain medium exhibits a singularity. This singularity, which is suppressed in a full multiple treatment using Mie theory, results in a substantially infinite internal field, surface field and scattering cross-section for the nanoparticle. In the presence of saturation, this mathematical singularity is suppressed, but still exhibits local fields that are much higher than those in conventional plasmon resonance, when the critical level of unsaturated gain is exceeded. In the exact Mie solution, the fields can be several orders of magnitude higher than the case without gain and will also result in gain saturation in the medium within a few radii of the structure.

In more detail, for the case of a metallic spherical particle of radius R₀<<λ, and a complex relative dielectric constant ε₁(ω), surrounded by an infinite medium with a complex relative dielectric constant ε₂(ω), the field inside the particle in the long wavelength limit of the theory is given by:

$$\underline{E} = {\underline{E}}_{0} ( \frac{{ɛ}_{2} - {ɛ}_{1}}{{ɛ}_{1} + 2 {ɛ}_{2}} ) \qquad ( 1 )$$

where ω and E₀ are the frequency and vector amplitude of the linearly polarized incoming plane wave.

For simple metals, ε₁(ω) can be approximated by the well accepted Drude response given by:

$$\begin{matrix}{ɛ}_{1} ( ω ) = 1 + {χ}_{1}^{′} ( ω ) + {ⅈχ}_{1}^{′′} ( ω ) where & ( 2 ) \\ {χ}_{1}^{′} ( ω ) = \frac{- {ω}_{p}^{2}}{{ω}^{2} + {γ}^{2}} and & ( 3 a ) \\ {χ}_{1}^{′′} ( ω ) = \frac{- {γω}_{p}^{2}}{{ω}^{3} ( 1 + \frac{{γ}^{2}}{{ω}^{2}} )} & ( 3 b )\end{matrix}$$

ωₚ is the plasma frequency of the metal and γ is the electron momentum dephasing rate which is typically two orders of magnitude smaller than ωₚ at room temperature. In the limit of

$$\frac{{γ}^{2}}{{ω}^{2}} 1 ,$$

the susceptibilities for the metal are given by:

$$\begin{matrix}{χ}_{1}^{′} = \frac{- {ω}_{p}^{2}}{{ω}^{2}} and & ( 4 a ) \\ {χ}_{1}^{′′} = \frac{- {γω}_{p}^{2}}{{ω}^{3}} & ( 4 b )\end{matrix}$$

Use of Eqs. (2) and (4a) in Eq. (1) results in:

$$\frac{{ɛ}_{2} - {ɛ}_{1}}{{ɛ}_{1} + 2 {ɛ}_{2}} = \frac{{ɛ}_{2} - 1 + \frac{{ω}_{p}^{2}}{{ω}^{2}} - {ⅈχ}_{1}^{′′}}{2 {ɛ}_{2} + 1 - \frac{{ω}_{p}^{2}}{{ω}^{2}} + {ⅈχ}_{1}^{′′}} \qquad ( 5 )$$

The metallic particle plasmon resonance occurs when the real part of the denominator in Eq. (5) equals zero. From previous work, with the ε₂(ω) assumed to have a vanishingly small absorption or gain, the resonance occurs at:

$${ω}_{0}^{2} = \frac{{ω}_{p}^{2}}{2 {ɛ}_{2} + 1} \qquad ( 6 )$$

This leads to a field enhancement within the particle given by:

$$E = {E}_{0} [ \frac{3 {ⅈɛ}_{2} {ω}_{p}}{{( 2 {ɛ}_{2} + 1 )}^{3 / 2} γ} - 1 ] \qquad ( 7 )$$

Equation (7) reflects the enhancement of the internal and external local fields surrounding the particle that lead to the absorption of metallic colloids and effects such as SERS. Typical values of ε₂˜1 give field enhancements of ˜10².

Of particular interest is when this enhancement is not limited by the incomplete vanishing of the denominator in Eq. (5). The presence of a strongly amplifying response in ε₂, can cause such a complete cancellation in the absence of saturation. The entire denominator in Eq. (5) can equal zero when both the real and the imaginary parts vanish simultaneously. To determine the conditions under which this occurs, the external medium (ε₂) response is modeled by:
ε₂(ω)=ε₂′(ω)+iε₂″(ω) (8)

where ε₂′(ω) is the real part of the dielectric response commonly used to determine the resonance in Eq. (6) and ε₂″(ω) includes all absorptive or amplifying responses of the surrounding medium.

The inclusion of an amplifying response in the medium surrounding the metal particle results in an internal field at plasmon resonance given by:

$$E = \frac{{E}_{0}}{β + 1} [ ( \frac{β}{2} - 1 ) + \frac{3 {ⅈɛ}_{2}^{′}}{{χ}_{1}^{′′} ( {ω}_{0} )} ] \qquad ( 9 )$$

where

$$β = \frac{2 {ɛ}_{2}^{′′} ( {ω}_{0} )}{{χ}_{1}^{′′} ( {ω}_{0} )} .$$

Comparing the real and imaginary parts of Eq. (9) for typical values of the parameters shows that E is dominated by the imaginary or out of phase response and complete cancellation of the denominator in Eq. (9) in the limit

$$\frac{γ}{{ω}_{0}} 1$$

results in a field singularity when β+1 approaches zero. This singularity occurs due to the cancellation of the dissipative force in the Drude model by an opposite force arising from the bound surface charge at the interface of the gain medium and the metal surface. Similar results can be obtained using the actual experimentally measured dielectric functions for the metal or plasmon-polariton material.

Modeling ε₂″ by a single symmetric gain line susceptibility, χ″₂(ω) centered at ω₀ yields the condition for plasmon singularity given by:

$${χ}_{2}^{″} ( {ω}_{0} ) = \frac{γ}{2 {ω}_{p}} {( 2 {ɛ}_{2}^{′} + 1 )}^{\frac{3}{2}} \qquad ( 10 )$$

where the facts that χ₁′(ω₀)=0 and ε₂′(ω) is determined by only the host properties are assumed. Using the relationship between the intensity gain coefficient, α(ω), the wave vector in surrounding medium and χ₁″(ω), the critical value of the resonant gain in the surrounding medium at which the plasmon singularity occurs, is calculated:

$${α}_{c} ( {ω}_{0} ) = \frac{( 2 {n}_{1}^{2} ( {ω}_{0} ) + 1 ) γ}{2 {cn}_{1} ( {ω}_{0} )} \qquad ( 11 )$$

where n₁²(ω₀)=ε₁′(ω₀) and c is the speed of light. Using n₁=1.3 and accepted γ values for silver and gold, α_{c}≈1.5×10³ cm⁻¹ and α_{c}≈2.25×10³ cm⁻¹ respectively. This magnitude of gain is attainable using dyes and semiconductor materials and structures as gain media. Using a value of σₑ=2.5×10⁻¹⁶ cm ² as a typical linecenter emission cross-section for laser dyes, the critical dye density of

$${ρ}_{c} = \frac{{α}_{c}}{{σ}_{a}} = 6.0 \times {10}^{18} {cm}^{- 3}$$

or a 10⁻² molar concentration. The critical gain required can be lowered significantly by the use of nanorods where interband damping is suppressed. Recent experiments on Au nanorods indicate that at least an order of magnitude reduction in α_{c} can be achieved in such systems.

For the plasmon singularity in silver at ˜420 nm, the divergence of the field within and outside the particle will be countered by the saturation of the surrounding medium. Using a two level model for the amplifying response of the surrounding medium in the rate equation limit, β is expressed as a function of the field (\vec{E}) outside the particle:

$$β ( \overline{E} ) = \frac{β}{1 + \frac{{\vert \overline{E} \vert}^{2}}{{E}_{s}^{2}}} \qquad ( 12 )$$

where Eₛ is the saturation electric field related to the saturation intensity of the transition through the Einstein B coefficient and the relaxation rate. Since \vec{E} is a function of the radial and angular coordinates, the exact self consistent solution must be solved beginning with the boundary conditions reflecting a spatial variation in ε₂. However, since it is the values of ε₂ at the boundary or surface that provide the restoring forces that drive the plasmon resonance, the estimate of |\vec{E}|˜E, the internal field and the maximum value at the surface when the incident field E₀ is small.

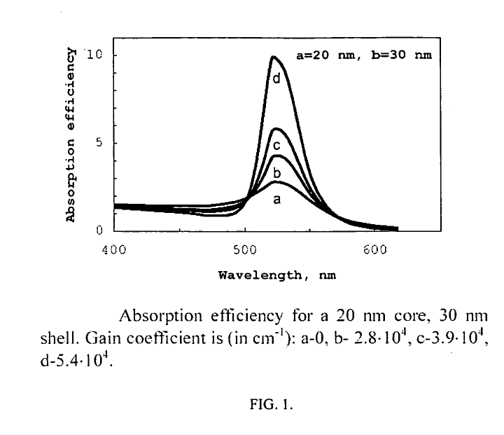

The complex dielectric function of the particle's surrounding, obtained by means of introduction of gain, transfers the normally complex natural frequencies of the sphere into the real domain, and thus makes it possible to increase local field intensities by as much as an order of magnitude, compared with those obtained near surface plasmon resonance of metal nanoparticles in non-amplifying media. These ideas are further developed in a rigorous manner as a generalized Mie solution for absorption of a coated gold nanosphere, utilizing numerical algorithms for evaluation of Bessel-Riccati functions and their derivatives. FIG. 1 shows the absorption efficiency for a 20 nm core, 30 nm shell including finite particle effects.

The field enhancement is mirrored by a gigantic increase in scattering cross-section. The ratio of the enhanced cross-section to the conventional plasmon resonance cross-section is arbitrarily large for arbitrarily small driving fields since the final field is locked at a value near Eₛ. Such a large enhancement in the presence of gain is expected to result in random laser action and light localization phenomena at exceedingly low concentrations of scattering particles. Furthermore, such a medium, unlike previous systems using high index of refraction particles such as TiO₂ and ZnO, would be transparent at all wavelengths outside the absorption bands of the gain medium.

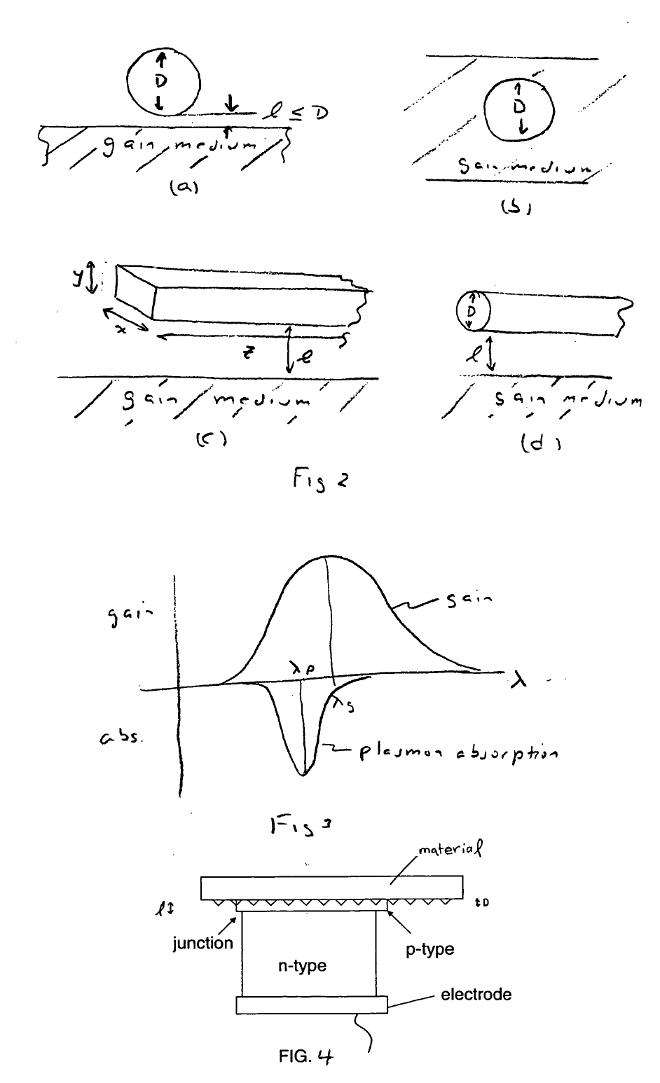

Referring to FIGS. 2a-d, multiple embodiments of the invention constructed in accordance with the above principles include (FIG. 2a) a spherical particle or shell of plasmon resonant material of diameter D (<<the wavelength of light λ) positioned a distance l≦D from the surface of the gain medium; (FIG. 2b) the particle or sphere of FIG. 2a immersed in the gain medium; (FIG. 2c) a rod of plasmon resonant material having dimensions x,y,z, where x, and/or y and/or z are <<the wavelength of light λ and (FIG. 2d) of a cylinder of diameter D (<<the wavelength of light λ) positioned a distance l≦D from the surface of the gain medium. The plasmon resonant material in one embodiment is a metal, for example silver or gold. In another embodiment the plasmon resonant material is an ionic crystal. In one embodiment the gain medium is a high gain laser dye such as rhodamine or coumarin which is optically or electrically pumped to excite the medium.

Referring to FIG. 3, the gain curve for the gain medium and the plasmon absorption curve of the plasmon material are depicted. The plasmon material and the gain medium are selected so that the plasmon absorption curve peak falls within the gain curve of the medium.

An application of this new material system is the further enhancement of Surface Enhanced Raman Scattering (SERS). The SERS mechanism relies on both the local field enhancement around the metal particles as well as the chemical coupling of the molecules to the metallic electronic response. Typically this latter chemical enhancement factor is of the order of 10². Using standard SERS and based on this factor, as well as the local field enhancement, single molecule detection of adenosine on colloidal silver clusters was achieved with 100 mW of laser power and a 1s integration time. Similarly, the SERS spectrum of a single hemoglobin molecule was recorded with 20 μW of power and a 200s measurement time.

Use of the SERS technique in the presence of a gain medium which has an unsaturated gain

exceeding the critical value could result in measurements with greatly reduced laser powers and times. For example, the measurement of hemoglobin on particles of gold or silver could be performed with picowatts of power. Further combination of SERS in the presence of critical gain with shape engineered and core-shell plasmon resonances can lead to tunability of the effect from the visible to the IR. This modification to SERS could potentially lead to a new class of ultra-sensitive and compact molecular detection, identification and sequencing instruments for biological, medical and genomics applications and potentially provide the necessary sensitivity to eliminate the need for PCR amplification.

Another application of the material of the invention is as a low threshold coherent emitter. In this case the combination of gain medium and plasmon resonant particles causes coherent radiation to be emitted from the material without the use of a cavity.

In still yet another embodiment an array of projects of plasmon resonant material is placed in close juxtaposition to, in or partially in a gain medium, with each of the projections having a height D less than or equal to the wavelength of light that will cause the plasmon resonant effect.

In still yet another embodiment the plasmon resonant material is placed in close juxtaposition to the gain junction of a laser diode. In still yet another embodiment the plasmon resonant material having a roughened surface placed in close juxtaposition to a P-N semiconductor junction, forming an electrode. As shown in FIG. 4, plasmon resonant material having a roughened surface with a dimension D (<<the wavelength of light λ) is positioned a distance l≦D from the P-N junction.

The foregoing description has been limited to a few specific embodiments of the invention. It will be apparent, however, that variations and modifications can be made to the invention, with the attainment of some or all of the advantages of the invention.

1. A method for generating a plasmon-polariton or phonon-polariton resonance effect comprising:
providing a structure capable of plasmon-polariton or phonon-polariton resonance;
providing a gain medium;
placing the structure in close juxtaposition to the gain medium.

2. The method of claim 1 wherein the structure is a nanoparticle.

3. The method of claim 1 wherein the structure is a nanostructure.

4. The method of claim 3 wherein the structure is a shell.

5. The method of claim 1 wherein the structure has a dimension D and the structure is placed within a distance less than or equal to D to the gain medium.

6. The method of claim 1 wherein the structure is placed within the gain medium.

7. The method of claim 1 wherein the structure is placed partially within the gain medium.

8. The method of claim 1 further comprising the step of stimulating the plasmon resonance.

9. A material for enhanced plasmon resonance comprising:
a gain medium; and
a structure capable of plasmon-polariton or phonon-polariton resonance positioned in close juxtaposition to the gain medium.

10. The material of claim 9 wherein the structure is a nanoparticle.

11. The material of claim 9 wherein the structure is a nanostructure.

12. The material of claim 9 wherein the structure has a plasmon absorption curve, wherein the gain medium has a gain curve and wherein the peak of the plasmon absorption curve lies within the gain curve.

13. A device for enhanced plasmon-polariton or phonon-polariton resonance comprising:
a gain medium;
a structure capable of plasmon-polariton or phonon-polariton resonance positioned in close juxtaposition to the gain medium; and
a device for stimulating plasmon-polariton or phonon-polariton resonance in the structure.

14. The material of claim 13 wherein the nanostructure is a nanoparticle.

15. The material of claim 13 wherein the structure is a nanostructure.

16. The material of claim 13 wherein the structure is positioned within the gain medium.
